(19) United States
(12) Patent Application Publication
(10) Pub. No.: US 2021/0396592 A1
(43) Pub. Date: Dec. 23, 2021

(54) Method and Apparatus for Non-Contact Temperature Measurement and Analysis for Detection of Symptomatic Conditions

(71) Applicant: DataGarden, Inc., Morgantown, WV (US)

(72) Inventors: John Edward Moody, Morgantown, WV (US); Clint Matthew Harvey, Morgantown, WV (US)

(21) Appl. No.: 17/354,028

(22) Filed: Jun. 22, 2021

Related U.S. Application Data
(60) Provisional application No. 63/042,281, filed on Jun. 22, 2020.

(51) Int. Cl. G01K 1/02; G01K 1/022; G01J 5/00; G01K 1/024

(52) U.S. Cl. CPC G01K 1/026; G01K 1/022; G01K 13/00; G01K 1/024; G01J 5/0003

(57) ABSTRACT

A technique for automated temperature monitoring relies on subject recognition in combination with contactless measurement of subject temperature at one or more measurement stations, with corresponding use of trend analysis. A multiplicity of advantages flow from the use of subject recognition and corresponding trend analysis, including more reliable detection of anomalous temperatures relative to trendlines determined for individual recognized subjects, with possible compensation for group trends, local environmental factors, variability in measuring equipment, etc.

### TECHNICAL FIELD

Disclosed techniques improve detection of symptomatic conditions using non-contact temperature measurement in combination with subject recognition and temperature analysis.

### BACKGROUND

Any environment in which people work in close proximity to one another raises concerns with respect to infectious diseases. Office buildings, manufacturing facilities, hospitals, and the like all involve potentially large and changing groups of people interacting within enclosed spaces and automated detection of anomalous temperatures of individuals in such environments offers an opportunity to check and, if necessary, isolate individuals who may be ill.

However, reliable automated detection of anomalous temperatures poses many challenges. Falsely or incorrectly flagging individuals as being symptomatic based on automated temperature detection causes significant inefficiency for the employer or other involved parties, not to mention the inconvenience imposed on the flagged individuals. Furthermore, not flagging individuals who are infectious and presenting with elevated temperatures causes the possible exposure of individuals and subsequent infection of additional parties. One advantageous recognition herein is that any practical incarnation of a non-contact temperature measurement system intended for flagging possible infectious conditions must mitigate or otherwise manage the problems of false positives and false negatives.

### SUMMARY

A technique for automated temperature monitoring relies on subject recognition in combination with contactless measurement of subject temperature at one or more measurement stations, with corresponding use of trend analysis. A multiplicity of advantages flow from the use of subject recognition and corresponding trend analysis, including more reliable detection of anomalous temperatures relative to trendlines determined for individual recognized subjects, with possible compensation for group trends, local environmental factors, variability in measuring equipment, etc.

An example embodiment comprises a computer system that includes a communication interface configured to receive signaling indicating a temperature measurement obtained for a person presenting at a non-contact temperature measurement station that is one among one or more such measurement stations within a facility. Processing circuitry included in the computer system is configured to evaluate the temperature measurement according to a trend analysis in which the temperature measurement is assessed in dependence on one or more trendlines determined from prior temperature measurements received for the person. The prior temperature measurements are represented in a data set corresponding to the person, where the data set is one among a plurality of data sets and is selected based on recognition of the person from among individual persons corresponding to respective ones of the data sets. The processing circuitry is configured to output signaling to one or more alerting systems, in response to the evaluation indicating a potential medical condition of interest.

Another example embodiment comprises a method performed by a computer system, where the method includes receiving signaling indicating a temperature measurement obtained for a person presenting at a measurement station that is one among one or more measurement stations within a facility. Further method steps or operations include evaluating the temperature measurement according to a trend analysis in which the temperature measurement is assessed in dependence on one or more trendlines determined from prior temperature measurements received for the person. The prior temperature measurements are represented in a data set corresponding to the person, where the data set is one among a plurality of data sets and is selected based on recognition of the person from among individual persons corresponding to respective ones of the data sets.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIG. 1 is a plot of example trends or changes in measured temperature, along with corresponding first and second derivatives of measured temperature.

FIG. 2 is a block diagram of a temperature monitoring system according to an example embodiment.

FIGS. 3 and 4 are block diagrams of a measurement station, according to example embodiments.

FIG. 5 is a block diagram of a temperature monitoring system according to another example embodiment.

FIG. 6 is a logic flow diagram of a method of temperature monitoring or screening according to an example embodiment.

### DETAILED DESCRIPTION

One aspect of the present disclosure is the use of subject recognition in conjunction with non-contact temperature measurement. Such use improves the utility and accuracy of determining whether a subject has an elevated body temperature, or other anomalous temperature trend, and can provide a multiplicity of notifications or other signaling to users, system components, and third-party systems, when temperature trends of interest are detected. Subjects are recognized and connected to multiple presentations at one or more measurement devices, and this approach dramatically improves the accuracy of determining trends of interest for further evaluation and notification purposes, by examining trends in the temperature measurements taken for a subject over time, at one measurement station or over multiple, spatially separated measurement devices.

Comparing temperature measurements against other measurement and trend patterns derived from historical readings assists in accurate evaluation of the temperature measurements, while providing data value or pattern compensation for temperature reading inconsistencies caused by effects. Example effects that are compensated according to the disclosed techniques include any one or more of differences in measurement device calibrations and quality, ambient environment effects on equipment and subject, common bodily effects from exertion, time-of-day, consumption of food and beverages, or other underlining conditions causing temperature reading fluctuations.

By observing trends in measured temperatures according to the disclosed techniques, rather than applying simple thresholds, to temperature measurements, the method(s) and apparatus disclosed herein offer reliable and automated early detection of potential medical conditions in individual subjects. Broadly, the disclosed method(s) and apparatus use subject recognition in conjunction with non-contact temperature measurements for analyzing trends in a subject's body temperature measurements and comparing those trends against historical temperature measurements, trends, and patterns, thereby improving the utility and accuracy of evaluating subjects for trending body temperatures that may indicate infectious diseases or other potential medical conditions of interest or concern, and providing notifications to configured recipients or systems when such areas of interest or concern are detected.

One advantage of the disclosed processing methods and apparatus configurations is the detection and notification of a potential medical condition of interest or concern for a subject prior to that subject reaching the higher body temperature values that are typically used to identify a potential medical condition of interest or concern with a single device reading. That is, rather than waiting for or responding to a temperature measurement that exceeds some fixed high threshold, the disclosed processing methods and apparatus evaluate temperatures against one or more trendlines that are reflective of the temperature characteristics of the individual subjects being monitored. Further, the measurements or the underlying temperature data sets may be compensated for characteristics of the measurement device(s), local environmental effects, group trends or characteristics, etc.

Example goals of evaluating subjects for upward trending body temperatures or other temperature-trend anomalies that may indicate a potential medical condition of interest or concern is the automated generation and outputting of a resulting notification or alarm. Example notifications are a message directing a subject to the process of a secondary evaluation, a door lock not opening, or notification to personnel tasked with monitoring or responding to such indications. Hence, an example apparatus, also referred to a system, uses subject recognition, non-contact temperature measurement, and a sophisticated underlying trend analysis approach, to provide reliable and early detection of potential medical conditions of interest.

The phrase “non-contact temperature measurement” refers to the reading of temperatures using a sensing device, such as a bolometer, that does not require the subject to have any type of physical contact with the device either directly (e.g., contact sensor, watch, patch, or band) or indirectly (something attached to clothing such as a tag, device, or lanyard). An example non-contact temperature measurement device is a thermal sensor, such as may be integrated in or associated with a camera or other recognition device that provides for recognition of individual subjects presenting at the measurement device. A “measurement station,” also referred to a “screening station,” may be understood as comprising associated recognition and temperature measurement devices, e.g., a location in a given building or other facility where a camera with thermal sensing provides for imaging passing subjects and acquiring corresponding temperature measurements. Subject recognition may be performed in conjunction with temperature acquisition or image data may be paired with respective temperature measurements for offline subject recognition.

“Subject recognition” in this context is the ability to recognize subjects while not necessarily identifying them, so that the system can differentiate between individual subjects with respect to temperature measurements acquired via individual measurement stations. Recognition, therefore, does not necessarily mean knowing the names of the subjects being monitored; it is enough for the system to have a mechanism for knowing which subject was involved in any particular temperature measurement, with some degree of reliability.

Recognition may be based on image processing or, additionally, or alternatively, may be based on other signaling, such as access-control signaling where badged individuals pass through an access-control area that includes a measurement station and a mechanism for reading or acquiring badge numbers or other unique data that allows differentiating one person from another. Subject recognition parameters may be shared or retrieved by a variety of means such as directly from one measurement device to another over a network, through centralized elements of the system such as a database, or though distributed computing elements or programs of the system.

Recognition does not preclude or exclude “identification,” however. That is, a system configured for automated temperature monitoring according to the disclosed techniques may be configured to identify the particular subjects presenting at the measurement stations and to link their corresponding data sets—temperature data—with one or more personal identifiers, such as names or employee numbers. Thus, the point is not to say that “recognition” precludes identification, but rather to emphasize that the system does not necessarily need to know the names of the subjects being monitored; rather, it needs only to differentiate one subject from another, so that different temperature measurements can be correlated to the respective subjects, for generating trendlines from the temperature measurements corresponding to the respective subjects, and for indicating which subject or subjects are exhibiting anomalous temperatures.

If the system incorporates identification of subjects, it may do so using various subject registering tools, comparison against known data stores, or communications with third party systems. While subject identification is not required for the recognition and processing of the trend analysis, it may have value regarding the generation of notifications. In at least one embodiment, the system performs a subsequent identification operation for a recognized subject, responsive to detecting an anomalous temperature trend for the recognized subject. In this way, temperature data sets maintained by the system for trend analysis of a given group of subjects e.g., the employees who work in a given facility—need not include names or other personally-identifying information.

Because subjects are recognized and are connected to multiple presentations at possibly multiple measurement devices, the evaluation processes are substantially improved through examining trends in temperature measurements over multiple measurements and/or spatially separated measurement devices. The disclosed temperature-monitoring/evaluation techniques exploit such an arrangement to provide dramatic improvements as compared to setting a common global threshold applied to individual measurements from all subjects. According to one or more embodiments disclosed herein, collected temperature data forms an overall data set indexed by subject, time, and location for later processing. This approach can be understood as developing respective data sets for individual subjects, based on recognizing which subject is associated with any given acquired temperature. Having data sets corresponding to respective subjects allows the system to determine trendlines specific to each subject, where the trendline(s) may reflect raw temperature or derived statistics, e.g., derivative trends, deviation trends, etc. Further, having such data provides for group-based compensations, among other things.

A basic illustration of example advantages considers the case of out-of-bounds temperatures, which might arise because of inaccurate readings or environmental influences. With the trend analyses disclosed herein, the system in one or more embodiments filters such measurements, e.g., using basic standard deviation routines. Such filtering is optional in one or more embodiments, and, in at least one embodiment, filtering is user-configurable. That is, an authorized user of the system has access to the filtering operations, for activating or deactivating filtering or configuring the extent or type of filtering.

One advantage of having spatially separated temperature measurement devices is the availability of measurements at strategic and accessible locations in a facility, such that temperature readings are more readily and easily available, thus yielding more data points for trend analysis. Using recognition, or identification as necessary, as a requirement for gating activities (e.g., checking into a system, opening or unlocking a door, turning on a light, etc.) naturally provides greater incentives or guarantees of collecting temperature measurements.

Additionally, because subjects are recognized, the evaluation processes take advantage of stored historical data of the subject in evaluating trends and determining if a trend should receive further evaluation or cause a notification by comparing a current trend against previous trend patterns looking for anomalies in the trend that could be indicative of temperature trends that are “out-of-character” for the subject. Similarly, the trend pattern comparisons may find that heightened temperatures during certain times of the day (e.g., around lunch time) are “in-character” for a particular subject and should receive less emphasis in determining whether the subject is exhibiting a condition of concern and signaling notifications.

Additionally, as supported by subject recognition, the evaluation process for temperature measurements in one or more embodiments takes advantage of additional historic data in evaluations, such as analyzing the measurements of other subjects as comparison groups within similar timeframes, conditions, and/or measurement devices to determine if any trending temperature values may also be common to those other subjects. By assessing group trends or characteristics, the system is operative to infer that external influences may be affecting temperature measurements. For example, high ambient temperatures at a given measurement device cause the temperature measurements made in that location to be higher. Further, the system in one or more embodiments recognizes variances between or among multiple measurement devices, resulting in automated temperature reading adjustments and compensations applied to specific temperature measurements or across multiple values of a trend. For example, an average reading at an ingress point over all people entering during a given hour that is several degrees higher than expected results in all temperature measurements made at that ingress point being compensated, e.g., reduced by system by the average degrees over the expected temperatures.

Additionally, as supported by subject recognition and known locations of temperature measurement devices, the system according to one or more embodiments evaluates activity metrics (e.g., the rate of travel from one temperature measurement device to another) and activity pathing (e.g., travel from the bottom of a stairwell to the top of a stairwell or from an outside location to an inside location) to infer levels of exertion that cause elevated temperatures. The system in one or more embodiments places less emphasis on elevated temperature measurements, responsive to such intelligent assessment of activity and paths, or it applies automated adjustments and compensations with respect to such measurements.

Advantageously, processing in one or more embodiments accounts for various externalities, such as by applying compensations for outside and room temperatures, humidity, HVAC states, etc. By applying compensations to individual temperature measurements or corresponding trend analyses as a function of environmental factors, detected differences in calibrations among temperature measurement devices, and/or the above-explained activity and pathing intelligence, the system in one or more embodiments enhances its reliability in detecting temperature trends that are indicative of potential medical conditions and reduces instances of falsely flagging subjects as needing medical assessment screening.

Finally, recognition of subjects at measurement locations also supports contact tracing capabilities, so that when a subject is determined to have a potential condition of interest or concern, either through initial or secondary confirmation practices, the system in one or more embodiments generates additional reporting, signaling, and/or notifications, as related to other subjects that were within specified temporal and spatial bounds of the subject determined to have a potential medical condition.

Subject recognition makes trend analysis possible. The system according to one or more embodiments performs trend analysis with respect to multiple temperature measurements made for any given subject at a single measurement station, and also in cases where multiple, spatially-separated measurement stations are used to collect temperature measurements from individual subjects. In an example configuration, subject-recognition templates are available locally at the measurement station(s), e.g., in the form of a facial-recognition template in implementations that base subject recognition on processing images of the subjects acquired in conjunction with acquiring temperature measurements for the subjects. Alternatively, image data obtained locally at the measurement stations may be transferred to a central location for processing and corresponding subject recognition.

Image processing and corresponding facial recognition constitutes one approach to subject recognition and the system uses such an approach in one or more embodiments. However, other bases for subject recognition are used in one or more other embodiments. Subject recognition can be achieved through many techniques/technologies including fingerprints, iris scans, general biometric techniques, access-control signaling, etc. Subject identification, of which subject recognition is a subset, can be achieved through matching biometric signatures to external data such as an employee database or through other means including swipe cards generally used for opening doors, computer readable employee identification, bar codes, or through human recognition and associated data entry at a measurement station.

In at least one embodiment, the system uses two or more recognition techniques. For example, some measurement stations may be associated with or include cameras or other image-acquisition sensors, with facial detection and recognition used to associate individual temperature measurements with the respective subjects corresponding to those measurements. Image-based recognition may be advantageous in hallways or other areas lacking specific access-control points. In areas with specific-access control equipment, e.g., card readers, eye scanners, fingerprint scanners, etc., subject recognition may be based on the acquired access-control information, which, for example, may be signaled to the (temperature monitoring) system by the involved access-control system. As such, it should be understood that the system may use any one or more techniques or bases for subject recognition, and the particular techniques or bases used may depend on cost targets, the nature of the facility involved, the nature of the work done by the subjects, etc.

Once recognition and/or identification is achieved and associated recognition templates and/or data are transmitted between measurement stations in the case of local processing or sent to a central processing server in the case of centralized recognition, trending of temperatures is then supported across temporally-separated measurements, i.e., temperature measurements taken for a given subject at different times, whether at one measurement station or at multiple, spatially-separated measurement stations.

In an example implementation of a temperature monitoring system, trending of temperatures in conjunction with subject recognition provides enhanced evaluation using a weighted sum of derivatives of the trending data invariant of subjects having differing baseline temperatures leading immediately to a more accurate screening process. In other words, analyzing temperature data readings of 99.5 F or 99.9 F degrees for a subject who has a known baseline temperature of 98.5 F degrees results in the subject not being of interest for secondary screening, while analyzing the same values for a subject with known baseline temperatures of 96.5 F results in the subject being of interest.

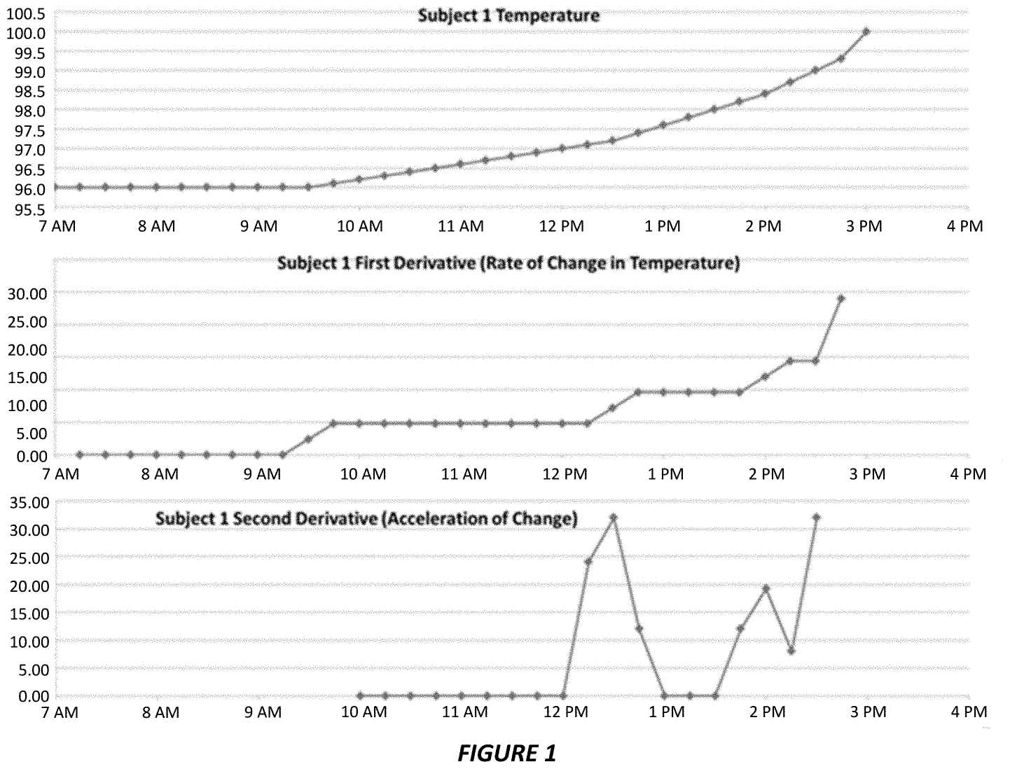

While configurations can be used to alter the parameters of a temperature screening process based upon user requirements, an example of trending is shown in FIG. 1. The diagram graphs example temperature measurements of a given subject over the course of a day. Note that the temperature at no time exceeds what might be considered to be a typical global threshold of 101 degrees Fahrenheit; however, the general upward trend (related to the first derivative) is used by the system according to one or more embodiments, to trigger further analysis or send a notification, e.g., to generate output signaling that flags the subject for further assessment.

Additionally, in the example, the rapidity of the change (related to the second derivative) is used by the system to trigger further analysis or send a signal indicating that this is a subject of interest (referred to as Next Action). Specifically, the following system calculation results in a trend-based analysis, where the system decides whether to take a Next Action by configuring the weights applied to the temperature measurement and first and second derivatives of the temperature data and applying a threshold to the resulting number. The resulting number may be referred to as a “Screening Factor” and mathematically denoted as “SF.” The system in one or more embodiments uses the Screening Factor as the basis for deciding whether to take a “Next Action,” which may be additional analysis or the outputting of signaling indicating that the subject is of interest.

An example formulation for the Screening Factor is calculated as

SF=(W₁)*T_{S1}+(W₂)*dT_{S1}/dt+W₃*d²T_{S1}/dt²,

where W₁, W₂, and W₃ are respective weights, with W₁ applied to an acquired temperature measurement T_{S1} for a person denoted as Subject 1, W₂ applied to the first derivative of temperature, and W₃ applied to the second derivative of temperature.

In the above case and in the following formulations, each derivative is calculated as a discrete derivative either as a left hand derivative only looking back in time, in which case dⁿT_{S1}/dtⁿ depends only on temperature measurements taken in the past and with the result being available for the most recent measurement, though possibly less accurate. Alternatively, the derivative may be centered around a measurement time in the past, such that backward looking and forward looking measurements are available to calculate the discrete derivative, thereby causing the calculated result only to be available for measurements taken in the past, dependent on how far forward the derivative looks into the future.

Use of forward looking and backward looking temperature measurements may yield a more accurate result. However, both approaches to derivative computation are valid, and the chosen approach may be dependent on implementation factors determined both by how rapidly results are required and how often measurements are taken. Note, too, that the temperature measurements used to calculate the derivatives are not necessarily only adjacent measurements taken in time. For example, the derivatives can be calculated based on looking at temperature measurements made at or about the same time every day, meaning that the sequence of temperature measurements used to calculate the derivative would be those measurements taken at the closest time to the selected time, over multiple days.

A more general expression for the Screening Factor is

SF=Σₙ₌₀^{∞}WₙdⁿT_{S}/dtⁿ,

where Wₙ=nth weight applied to T and its derivatives, T_{S}=measured temperature at time t for a given Subject, and dⁿT/dtⁿ=nth derivative of temperature at time t.
Ultimately, the decision to take further action, such as performing a subsequent Next Action then is based on applying a threshold to SF, where the threshold may be user-configured:

SF>=thₕ Perform Next Action

thₗ<=SF<=thₕ Do not Perform Next Action

SF<=thₗ Perform Next Action

Where thₕ=threshold high limit
thₗ=threshold low limit

In FIG. 1, consider an example calculation of SF for the temperature measurement acquired for Subject 1 at 3:00 PM:

SF=(0.001)*100+(0.05)*48+(0.01)*32=2.82,

where

W₀=0.001

T=100

W₁=0.05

dT/dt=48

W₂=0.01

d²T/dt²=32

SF according to the foregoing numbers is 2.82.

Assuming that the configured threshold used by the system for assessing SF is 2.5, a calculated value of 2.82 for SF triggers the system to send signaling indicating that Subject 1 requires secondary medical evaluation. Notably, the system detects that Subject 1 may have a medical condition, without the temperature measurements taken for Subject 1 ever exceeding 100 degrees Fahrenheit.

Additionally, as supported by subject recognition, a temperature analysis performed by the system may take advantage of other data, such as when taking a Next Action. In an example of such operation, the system separates subjects into groups and further performs trend analysis of groups. For example, when all subjects in an overall population of subjects are taken as a group and show a group trend in upward temperature at a given measurement location, the system in one or more embodiments infers that external influences are driving the increase (e.g., a high outdoor temperature or other environmental factor is influencing temperature measurements).

In such case, the system calculates a weighted sum much like that used by it for individual temperature measurements with the difference being that the weighted sum represents a group SF. The group SF either adds to or subtracts from the individual Screening Factor for a current measurement subject. In other words, the system compensates or adjusts the value of the Screening Factor determined for an individual subject, based on group data. The equation below illustrates an example process implemented by at least one embodiment of the system, for determination and use of group-based SFs:

SF_{Group}=Σₙ₌₀^{∞}WₙdⁿT_{Avg}/dtⁿ*W_{Group},

where Wₙ=nth weight applied to T_{Avg} and its derivatives, T_{Avg}=average measured temperature of group at time t, dⁿT_{Avg}/dtⁿ=nth derivative of average temperature of group at time t, and W_{Group}=group weighting factor.

In an example of how the system in one or more embodiments uses a group screening factor with respect to a given subject presenting at a measurement station, the system computes the SF for the subject as follows:

SF=Σₙ₌₀^{∞}WₙdⁿT/dtⁿ+SF_{Group},

where Wₙ=nth weight applied to T and its derivatives, T=measured temperature at time t, and dⁿT/dtⁿ=nth derivative of temperature at time t. Of course, SF_{Group}=Screening Factor for the group, and SF=Screening Factor for the subject for which the temperature T was taken at time t.

Ultimately, the decision by the system to perform a Next Action, such as further analysis or sending a notification or output signal indicating that the subject is of interest, then is based on applying a user configured threshold to the calculated SF for the subject. For example, the decision evaluation may be represented as:

SF>=thₕ→Perform Next Action

thₗ<=SF<=thₕ→Do not Perform Next Action

SF<=th₁→Perform Next Action

where thₕ=threshold high limit, and thₗ=threshold low limit. The Next Action taken for exceeding the low threshold limit may be the same or different as the one taken for exceeding the high threshold limit.

As an example implementation, the system triggers additional analysis as a Next Action in response to detecting a temperature anomaly for a recognized subject even though the most recent temperature measurements acquired for the subject are all within the range of normal temperature expected for a human being. As particular example, the system triggers the Next Action in response to detecting that the most recent temperature measurement for a given subject is higher than “r” previous measurements for the subject, and that the most recent measurement continues an upward trend for the subject; for example, the r prior measurements exhibit an upward trend from 96F degrees, with the most recent measurement being 98 F degrees.

In an example embodiment, the additional analysis triggered is the system determining whether the higher temperature value is within thresholds for the subject according to data closely related to the temporal and spatial patterns of temperature measurement devices traversed by the subject. Particularly, the system may assess temperature data for other subjects or for a group of subjects that have temperature measurements closely related to those of the subject at issue, e.g., subject involved in a similar traversal of measurement devices, or measurements taken from the same measurement devices around the same time or at similar times. Such data can be used to determine an adjusted SF for the individual subject or for determining correspondingly adjusted thresholds for evaluating the SF of the individual subject. If the individual SF for the subject exceeds the lower or upper threshold with such compensation in place, the system triggers a further Next Action that involves outputting signaling, e.g., a signal sent by the system to a viewing station indicating the subject has been detected as having an elevated temperature and that a manual medical examination should be performed on the subject.

In more laymen terms of the example embodiment, a subject registered a temperature that was higher than a configured threshold since a last temperature reading for the subject. Having determined that the last several readings for the subject were showing some upward trend, the example system compiles and analyzes historical temperature data of the subject to determine if these trends are a normal pattern for the subject. Responsive to determining that the upward trend is not normal, the system further checks to see if other groups of individuals exhibited similar higher temperature measurements at the measurement station used to acquire the individual subject's last reading, as compared to previous measurement locations associated with acquiring prior measurements for subject in the group.

All or most subjects exhibiting a temperature reading from a particular measurement station that deviates from the temperature trendlines exhibited by those subjects suggests an out-of-calibration condition for the involved measurement station or some other local environmental effect. Thus, if the system determines that such local effects are in play, it may adjust or compensate the SF calculation with respect to the temperature measurement acquired for any given individual subject presenting at the measurement station. However, if the system determines that local effects are not in play, i.e., that the temperature data for other subjects presenting at the same measurement station does not exhibit the same pattern or jump as observed for the individual subject at issue, it does not apply such compensation, meaning that the calculated SF for the given individual subject will be out of bounds and trigger the system to generate output signaling that flags the individual for manual assessment.

As noted earlier, recognition of subjects at measurement locations also supports contact tracing so that if a subject, after secondary screening, is determined to be infectious, all subjects at the measurement station near the same time can be contacted and screened as necessary. Contact tracing is based on, for example, spatially and temporally identifying or filtering subjects with thresholds applied individually or simultaneously to known subject presentation times at measurement locations. For example, tracing applies to all subjects who were measured within 5 minutes prior to the known subject presentation at the involved measurement station or within 15 minutes after at any station within 5 meters of the involved measurement station.

Finally, activities and behaviors can be inferred from the presentation of recognized subjects at specific measurement locations, or at a defined sequence of measurement locations. Upon inferring that a particular subject has engaged in or is engaged in an activity, the system may apply specific evaluation routines or evaluation compensations for the involved temperature measurements. For example, presentation of a subject at a measurement location normally used for ingress to a place of business on a hot day provides the basis for making the evaluation of the measurement location less dependent on the initial temperatures at this measurement location and also at other measurement locations for a specified, or automatically generated, period of time when evaluating temperature trends.

Additionally, if a subject were to present at a location adjacent to a stairwell and then present at another location on a different floor within a short time span, the system in one or more embodiments infers that the subject recently walked up the steps. Consequently, the system may use a reduced sensitivity of the screening criteria. For example, responsive to the system inferring that a subject presenting at a measuring station nearby a stairwell has just ascended the stairs, the system may discount or otherwise compensate the temperature measurement acquired for that subject, if the system infers that the subject has just finished walking up the stairs.

Such inference “gating” of temperature measurements can be specified with configuration of options within the system, in one or more embodiments. Additionally, or alternatively, inference gating may be determined indirectly and automatically by normalization of trend data against historical data, where subjects fall within temporal bounds for using the same temperature measurement devices.

Considering the foregoing possibilities and variations, in at least one embodiment of the system, the ultimate decision as to requiring Next Actions then becomes:

SF^{Group}=Σₙ₌₀^{∞}Wₙd^{t}T_{Avg}/dtⁿ*W_{Group},

where Wₙ=nth weight applied to T_{Avg} and its derivatives, T_{Avg}=average measured temperature of group at time t, dⁿT_{Avg}/dtⁿ=nth derivative of average temperature of group at time t, and W_{Group}=group weighting factor.

Then, for a given individual subject presenting at a measurement station, the calculated SF is:

SF=Σₙ₌₀^{∞}WₙdⁿT/dtⁿ+SF_{Group},

where Wₙ=nth weight applied to T and its derivatives, T=measured temperature at time t, and dⁿT/dtⁿ=nth derivative of temperature at time t. Then, applying inferred activities, the adjusted or compensated SF for the individual subject becomes:

S=S+Σₙ₌₀^{∞}W_{IAn}Iₙ/t,

where W_{IAn}=weight associated with inferred activity n, Iₙ=intensity of inferred activity (e.g., in the case of stair climbing, how many floors/s), and t=time since activity occurred (potentially set to a fixed value after a given time).

Ultimately, then, the decision by the system to process a Next Action in such embodiments is based on applying a user configured threshold to SF, as follows:

SF>=thₕ→Perform Next Action

thₗ<=SF<=thₕ→Do not Perform Next Action

SF<=thₗ→Perform Next Action

Here, thₕ=threshold high limit, and thₗ=threshold low limit.

With the above details in mind, one embodiment herein is a method for utilizing subject recognition in conjunction with non-contact temperature measurement to improve the accuracy of screening for early detection of upward trending body temperatures over time that may indicate a potential medical condition of interest. Subject recognition in conjunction with non-contact temperature measurement provides the ability to analyze spatially and/or temporally separated temperature measurements for indicators of upward trending temperature. Saying that two temperature measurements are spatially separated means that they were taken at different locations, e.g., at different measurement stations positioned at different locations within a facility. Saying that two temperature measurements are temporarily separate means that they were taken at different times, e.g., at least several minutes apart.

Analyzing separate temperature measurements acquired for a given subject in one or more embodiments of the method includes routines that analyze the trending temperature data patterns against historical temperature data patterns. The historical data patterns being analyzed are chosen, for example, based on data availability to “best match” the current temperature patterns by selecting trending data points based on measurement locations, temporal separation of the readings, time of day of the readings, weather conditions, or other matching factors.

As a particular example, the historical data patterns being analyzed are chosen based on data availability to “best match” the current temperature patterns by selecting trending data points generated by the same subject. The historical data patterns being analyzed also may be chosen based on data availability to “best match” the current temperature patterns by selecting computationally derived trending data points generated by groups of other subjects.

In one or more embodiments, the method includes selectively performing additional analysis of temperature measurements, where deciding the need for additional analysis is based on a subject's temperature trend values being evaluated after alteration or compensation that is based on factors of the subject's temperature points based on historical trends followed during a week day and other comparative time periods. Additional analysis and the determination of the need for further analysis may be based on a subject's temperature trend values being evaluated after alteration or compensation based on factors of historic group trending (e.g., all employees following a general change in average temperature) followed during a week day and other comparative time periods.

In the event of confirmation of a subject exhibiting a temperature trend that is indicative of a medical condition of interest, contact with other subjects can be inferred by reviewing collected measurements of recognized subjects that are within a configured time interval or distance or both of known locations of the subject during the day, based on when/where temperature measurements occurred.

One or more embodiments of the method infer activities of measurement subjects. The parameters of screening algorithms are changed, for example, based on the time and intensity of the inferred activity. With activity inferences, a high temperature may be given less weight if the temperature measurement is taken for a subject that the system infers as having recently engaged in an activity, such as climbing a stairwell. The degree of discounting or compensation may be tied to an inferred intensity of the activity. In one example, inferring activity is achieved by the system knowing placements of measurement stations and applying an “exertion” factor associated with subjects moving from one measurement station to another, such as based on distance, the presence of stairs between the locations, and the rate of travel, such as can be assessed based on the time between measurements, at least for certain spatial arrangements of measurement stations. The system uses inferred activity to calculate compensation factors that are applied to one or more readings of a temperature trend.

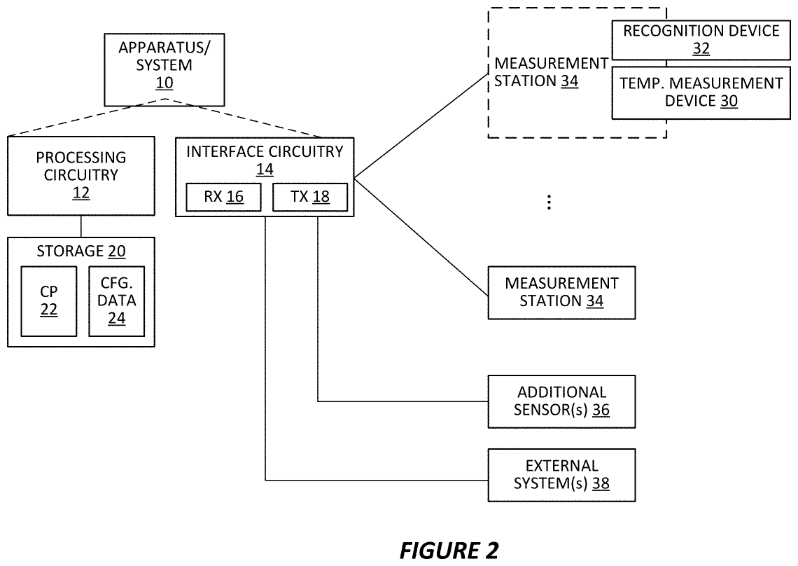

FIG. 2 depicts one embodiment of an evaluation system 10, which is elsewhere referred to as temperature measurement or monitoring system or simply “system,” where the system 10 provides temperature compensation and measurement scoring. The word “apparatus” may be used interchangeably with the word “system.”

The example system 10 comprises processing circuitry 12 and interface circuitry 14 for coupling input information or signaling into the processing circuitry 12 and output information or signaling from the processing circuitry 12. The interface circuitry 14, which also may be referred to as input/output circuitry, includes receiver circuitry 16 and transmitter circuitry 18, in one or more embodiments, for receiving incoming signaling and sending outgoing signaling. Incoming signaling comprises, for example, temperature measurements and corresponding recognition information. Outgoing signaling comprises, for example, notification signaling indicating that given subjects require manual medical screening.

The processing circuitry 12 comprises fixed circuitry, programmatically-configured circuitry, or a mix of fixed and programmatically-configured circuitry. Non-limiting examples include one or more microprocessors, digital signal processors, field programmable gate arrays, application specific integrated circuits, or other digital processors. The processing circuitry 12 includes or is associated with storage 20, which provides, for example, short-term working memory for program execution and data-processing. Additionally, or alternatively, the storage 20 provides longer-term storage for computer-program instructions, for execution by the processing circuitry 12, and may store various items of operational or configuration data. For example, the storage 20 comprises one or more types of computer-readable media, such as DRAM, SRAM, FLASH, SSD, etc.

In at least one embodiment, the storage 20 stores computer-program instructions (“CP 22” in the diagram) that, when executed by the processing circuitry 12, causes the system 10 to carry out the method(s) described herein. The storage 20 also may store configuration data (“CFG. DATA 24” in the diagram). Configuration data 24 comprises, for example, user-configurable thresholds for evaluating temperature data, information about the population of subjects for which the system 10 provides temperature monitoring, e.g., recognition data such as facial templates, access-control information such as badge numbers, etc.

In at least one embodiment, one or more processors included in the system 10 are specially adapted to perform the temperature-monitoring operations described herein (i.e., the described temperature screening evaluations), based on their execution of computer program instructions 22. The system 10 in conjunction with subject recognition may be referred to as simply “system” for short, and it may be implanted as or embodied at least in part in a computer server executing computer program instructions 22 implementing the operations described herein.

The system 10 further includes or at least interfaces with one or more non-contact temperature sensors 30, which also may be referred to as temperature measurement devices. A given temperature measurement device 30 may include or at least be spatially and logically associated with a recognition device 32. A given pairing of temperature-measurement and recognition devices 30, 32 may be referred to as a measurement station 34. “Screening station” is an alternate name for a measurement station 34. The system 10 may receive temperature measurements and recognition signaling from one measurements station 34 or from multiple measurement stations 34, e.g., at different screening locations within a building or other facility. FIG. 2 depicts multiple measurement stations 34.

Individual measurement stations 34 are operative for detecting temperatures of subjects in an area of interest, such as ingress/egress areas in place of business. In addition, some method of recognizing subjects is included in the same area and interfaced with computer systems which correlates the recognition and measured temperature. Example recognition techniques include facial recognition, fingerprints, retinal scans, general biometrics, identification swipe cards, and computer readable codes such as barcodes, etc. Therefore, as noted above, the combination of elements providing for subject recognition in conjunction with temperature acquisition may be referred to as a “measurement station” or “screening station.”

In addition to recognition, in one or more embodiments, the system 10 correlates a recognized subject with external data, for identification of the subject. Such as matching facial images to a database of names or employee numbers. When identification occurs, additional data collected from outside the system 10 may be used in further refining the screening process—e.g., based on the identity of the subject.

In one example implementation of the system 10, the system operates 10 with multiple facial recognition devices and non-contact temperature detectors as measurement stations 34, and the system 10 makes screening decisions for an individual subject based on a weighted sum of derivatives of temperature measurements for the subject with a threshold applied. Such operations result in a binary decision related to the need for secondary scanning.

In another example implementation of the system 10, other features of the measurement data are used in conjunction with the weighted sum of derivatives in making the screening decision such as minimum, maximum, average, and/or other statistical measures, general curve shape (which may or may not be indicative of various classes of illnesses), and/or any other feature of the measurement data.

In an example of the system, learning algorithms are applied to collected measurements. The learning algorithms provide further improvements to the screening algorithm, offering advantages such as dynamic improvement of the algorithm over time.

In at least some embodiments, the system 10 is configured to use the typical variation in temperatures of an individual subject to adjust the temperature measurements and/or the sensitivity of the screening algorithm used to evaluate the temperature measurements collected for the individual, to make more reliable decisions about whether the individual merits manual medical screening and/or whether further analysis of temperature measurements for the individual is warranted. For example, the system 10 may determine that the SF calculated for the individual using the most recent temperature measurement for the individual exceeds defined thresholds. The system 10 may perform such calculation without considering group data or local environmental effects. If the SF exceeds a defined threshold, the system 10 may perform a more sophisticated calculation of the SF, using compensation derived from relevant temperature trends discerned from the group data. If this “compensated” SF exceeds a defined threshold, then the system 10 outputs notification signaling, indicating that manual screening is required. Of course, in other embodiments, the system 10 may simply perform the more sophisticated, compensated SF calculation by default.

In at least some embodiments, the system 10 uses the typical variation in temperatures of groups of subjects (based on both internal criteria such as the time of day or external criteria accessed through identification), to adjust the temperature measurements and/or the parameters of the screening algorithm, to compensate for variances from outside factors including subject baselines, sensor calibrations and accuracies, and ambient and environmental factors. In at least some embodiments, the system 10 provides or otherwise enables contact tracing of individuals determined to be infectious through secondary screening, based on collected measurements and known location/times of recognized subjects with a threshold applied to distances and/or times of known measurements from the infectious subject.

In at least some embodiments, the system 10 correlates additional information related to the identity of subjects to better compensate for factors associated with individuals or groups of individuals as defined based on both temperature measurements and other correlated data (e.g., male/female groups). Examples of this additional information can include sex, race, shift, occupation, weight, outdoor temperature, indoor temperature, humidity, brightness, past illnesses, observed behavior (e.g., rubbing of face/forehead), and other data that may impact temperature measurements and trending. In at least some embodiments, subject activities are inferred from known measurement locations and times resulting in the adjustment of the screening algorithm based on the intensity and time of the inferred activity.

Outputting indications that manual screening is required comprises, for example, outputting data or signaling indicating the need for secondary screening. Such signaling may include visual indications (lights), audible indications, prevention of entry (e.g., turnstiles, computer controlled door locks), messages sent to appropriate personnel, etc.

With the above embodiments in mind, a system 10 in an example embodiment provides sophisticated temperature monitoring for individual subjects, based on subject recognition in combination with trend analysis. In the example embodiment, the system 10 is configured to: receive signaling indicating a temperature measurement obtained for a person presenting at a measurement station that is one among one or more measurement stations within a facility; evaluate the temperature measurement according to a trend analysis in which the temperature measurement is assessed in dependence on one or more trendlines determined from prior temperature measurements received for the person, the prior temperature measurements represented in a data set corresponding to the person, where the data set is one among a plurality of data sets and is selected based on recognition of the person from among individual persons corresponding to respective ones of the data sets; and output signaling to one or more alerting systems, in response to the evaluation indicating a potential medical condition of interest.

In one or more embodiments, the “trend analysis” processing performed by the system 10 comprises one or more types of statistical analysis that reveal one or more temperature patterns, with the system 10 detecting anomalies in the pattern(s). For example, the trend analysis carried out by the system 10 uses temperature measurements and one or more derivatives of those measurements, such as first and second derivatives, to assess whether further actions should be taken with respect to a given subject.

In at least one embodiment where trend analysis is derivative-based, a data set maintained for a given subject includes recorded temperatures, which allows the system 10 to compute first and second derivatives of those temperatures. See the example plots in FIG. 1. This approach allows the system 10 to detect temperature measurements that are anomalous with respect to historical temperature measurements and corresponding rate-of-change behaviors reflected in the derivatives.

In another example of trend analysis, the system 10 assesses the “rolling” value of standard deviation in temperature measurements taken for a subject, e.g., standard deviation in temperature for the subject over the last “X” days. Temperature measurements exceeding the observed standard deviation may be detected as anomalous and used as triggers for further analysis or notification. In an example extension, the system 10 may additionally track one or more higher-order deviations, e.g., second and third standard deviations, in measured temperature for the subject. A temperature measurement for the subject that exceeds these higher-order deviations triggers an escalated response by the system 10, such as immediately sending notification that manual medical screening is needed.

More broadly, the trend analysis carried out by the system 10 is a statistical analysis that accounts for characteristic temperatures or patterns thereof, for the individual subjects being monitored and the corresponding logic to detect uncharacteristic or anomalous deviations in such patterns. The system 10 may maintain data sets for respective subjects along with group data, such as group averages, group trends, etc.

As for collecting temperature measurements, as previously described, the system 10 interfaces with one or more measurement stations 34 or at least receives information originating from one or more measurement stations 34. As noted, a “measurement station” may be regarded as a “measurement location” where temperatures of individual subjects are measured in conjunction with recognition of the individual subjects. Also as noted, “recognition” of a subject does not necessarily mean identifying the subject by name; rather, it denotes the process of associating temperature measurements to specific subjects, so that the temperature measurements collected over time for a particular subject are linked to that subject and available for trend analysis.

The system 10 may receive information from a measurement station 34, e.g., positioned within a building at a location expected to be passed by several times per day by the typical employee (or employer protocols may mandate that employees visit the measurement station multiple times per day). In at least one embodiment, the system 10 receives information from two or more measurement stations 34 strategically distributed within the facility at issue. Advantages flowing from the use of multiple measurement stations 34 include the ability to collect multiple temperature measurements from spatially-separated measurement points as the monitored subjects go about their daily activities.

The system 10 may include or interface to any number of additional sensors 36 or, again, at least receive information originating from one or more additional sensors 36. Example additional sensor(s) 36 are ambient temperature sensors that allow the system 10 to account for ambient temperatures (indoor or outdoor) that are relevant to its assessment of individual subject temperatures and/or analysis of the statistical properties of the temperatures collected for one or more groups of subjects at given measurement stations 34 or across multiple measurement stations 34.

Further, the system 10 may interface with or at least receive information originating from one or more external systems 38, such as access control systems. As such, in one or more embodiments the system 10 can trigger temperature measurements coincident with access-control events like badge swipes, room entry/room exit, etc. Even where the temperature measurements are made automatically, e.g., upon presence sensing, the access-control information can be used by the system 10 to correlate or track movement of a subject within a facility.

Essentially any kind of measurement stations 34 can be used with the system 10. For example, the recognition device 32 and the temperature measurement device 30 could be “dumb” devices that are locally interfaced to a modem, computer system, or other device with the intelligence and communicative coupling needed to convey information back to the system 10, either via direct connection or via one or more intermediate networks, e.g., an Internet-based connection. In other instances, a measurement station 34 itself may be a “smart” device or module, with integrated communication capability. In any case, the system 10 in one or more embodiments may be considered to include the measurement station(s) 34, while in other embodiments, the measurement station(s) 34 are not considered part of the system 10 and merely provide the system 10 with the information needed for the contemplated screening operations, e.g., the screening stations may be owned by the owner of the involved building or facility.

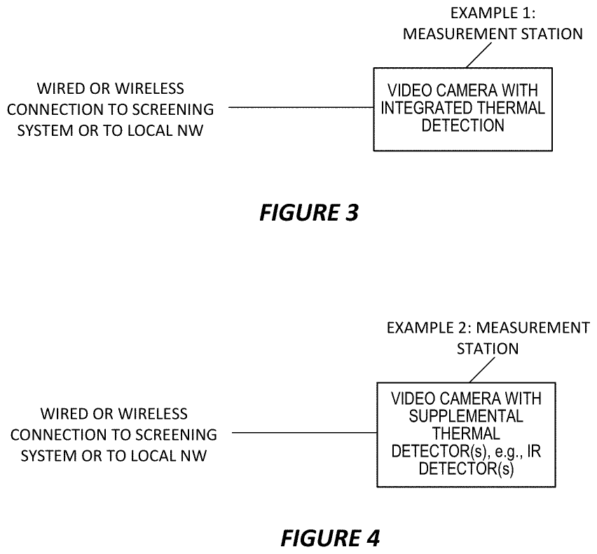

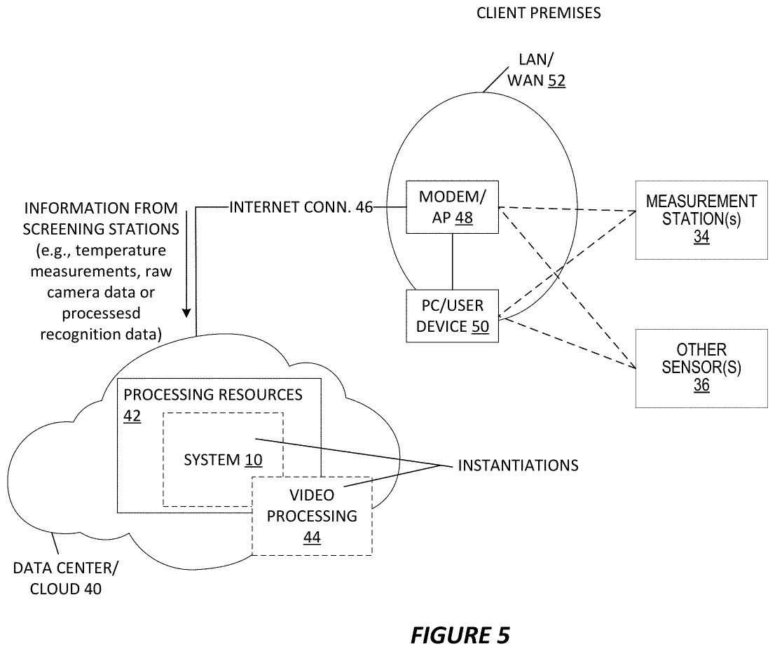

FIGS. 3 and 4 depict non-limiting examples of measurement-station implementations. Correspondingly, the system 10 may be local (on premises) or may be remote from the facility in which the measurement stations 34 reside. In at least one example, the system 10 is cloud-based, as depicted in FIG. 5.

The system 10 is, for example, virtualized within the data-center computing systems 40, with access to supporting storage of temperature measurements and subject-recognition data, along with any user-configured settings, for the computation of Screening Factors as described herein. There may be multiple instantiations of the system 10, e.g., on a per client basis, such as where one or more measurement stations 34 are associated with a particular address or client account are managed together as a group.

Such system instantiations are supported by processing resources 42 of the data center/cloud 40, and they may include or be associated with instantiations of video processing systems or modules 44, e.g., in embodiments where subject recognition is based on the processing of subject images.

Thus, in at least one embodiment of the system 10, the system 10 receives temperature measurements and subject recognitions made by equipment that is remote from the system 10, with the example depiction illustrating an internet-based connection 46 between one or more measurement stations 34 and a corresponding instance of the system 10, as implemented within the processing resources of the data center/cloud 40. Here, the processing resources 42 comprise a host computing platform, for example, which may be a virtualized server instantiated on underlying physical processing, memory, and input/output circuitry.

The remote measurement stations 34 and any additional sensors 36, such as ambient temperature sensors, access-control sensors, etc., may interface directly or indirectly with the internet connection 46. In FIG. 5, the measurement station(s) 34 and other sensor(s) 36 interface with a modem or access point 48 and/or PC or other user device 50, with the local communication linking supported by a LAN or WAN 52 that provides communication coverage at the facility in question. The example of FIG. 5 is not limiting, however, and various other arrangements may be used for communicatively coupling the system 10 to remote measurement stations 34.

The internet connection 46 in FIG. 5 also may be used as a link for the system 10 to receive user input, such as hardware make/model of the temperature measurement devices 30 and/or the recognition devices 32, configuration information, desired default settings, etc. And, of course, in one or more other embodiments, the same or similar functionality is delivered via dedicated software applications or apps (including responsive web applications).

One of the advantages of the cloud-based embodiment of the system 10 is that the only hardware needed at the monitoring site is a temperature measurement device 30 and a recognition device 32 that can be connected to the internet or otherwise communicatively coupled to the system 10. In other environments, such as environments governed by strict privacy requirements, it may make more sense to host the system 10 onsite with local connectivity between the measurement device(s) 30 and recognition device(s) 32 and the system 10, along with any client computers or other image displays that are used by the system 10 in one or more embodiments for outputting graphical depictions of the measurement process and results derived.

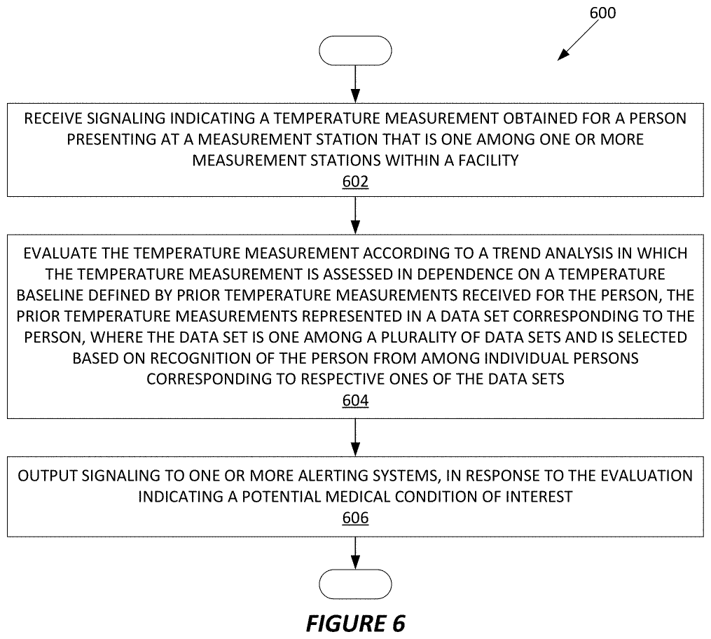

Whether the system 10 is implemented via cloud processing resources or via dedicated resources, and whether implemented locally at the involved facility or remote from the facility, FIG. 6 illustrates a method 600 of temperature monitoring or screening according to one embodiment.

The method 600 is performed by a computer system and includes receiving (Block 602) signaling indicating a temperature measurement obtained for a person presenting at a measurement station that is one among one or more measurement stations within a facility. The method 600 further includes evaluating (Block 604) the temperature measurement according to a trend analysis in which the temperature measurement is assessed in dependence on one or more trendlines determined from prior temperature measurements received for the person, the prior temperature measurements represented in a data set corresponding to the person. The data set is one among a plurality of data sets and is selected based on recognition of the person from among individual persons corresponding to respective ones of the data sets. The method 600 further includes outputting (Block 606) signaling to one or more alerting systems, in response to the evaluation indicating a potential medical condition of interest.

The one or more measurement stations comprise, for example, one or more video cameras for recognition of persons, each video camera integrating or being associated with a thermal detector, for measuring temperatures of persons imaged by the video camera.

Receiving the signaling indicating the temperature measurement comprises, for example, receiving the signaling via an Internet connection that communicatively couples the computer system to the one or more video cameras, or to a remote computer system that is local to the one or more video cameras. The signaling may be received locally, as another example.

Receiving the signaling comprises, for example, receiving first signaling comprising the temperature measurement. Such first signaling may be received directly or indirectly from the measurement station 34 at which the temperature measurement was determined. Receiving the signaling may further comprise receiving second signaling indicating the person, with the computer system using the second signaling to recognize the person and using the recognition to select the corresponding data set from among the plurality of data sets. The second signaling comprises image data, for example, with the method 600 then including the step or operation of recognizing the person based on the computer system processing the image data.

Additionally, or alternatively, the second signaling comprises access-control data associated with authorized persons entering or exiting access-controlled areas associated with the one or more measurement stations. Correspondingly, the method 600 in such cases further includes the step or operation of the computer system recognizing the person from the access-control data.

The one or more measurement stations may comprise multiple measurement stations at separate locations within a facility. Correspondingly, in at least one embodiment, the method 600 further includes the computer system comparing temperature measurements collected over time at respective ones of the multiple measurement stations, or comparing statistics derived therefrom, determining differences in measurement calibrations among the multiple measurement stations based on the comparisons, and compensating the temperature measurement or the trend analysis for the differences in measurement calibrations among the multiple measurement stations.

The trend analysis performed as part of the method 600 comprises, for example, deriving a screening factor, denoted elsewhere herein as an “SF.” The SF depends on the temperature measurement and accounts for a historical temperature pattern of the respective person. Correspondingly, evaluating the temperature measurement comprises the computer system determining whether the screening factor exceeds a threshold.

In at least one embodiment of the method 600, the screening factor is normalized according to the historical temperature pattern of the person, and the computer system maintains a plurality of historical temperature patterns corresponding to respective ones among a plurality of persons. As such, evaluating a particular temperature measurement received for a particular person from among the plurality of persons comprises evaluating the temperature measurement according to the historical temperature pattern corresponding to the particular person. The screening factor may further depend on a group screening value derived from temperatures observed for the plurality of persons.

Outputting the signaling to the one or more alerting systems comprises, according to one or more embodiments of the method 600, initiating activation of a visible indicator or an audible indicator at the measurement station used to obtain the temperature measurement. Additionally, or alternatively, outputting the signaling to the one or more alerting systems comprises the computer system sending one or more messages to one or more designated authorized persons.

An example computer system includes a communication interface configured to receive signaling indicating a temperature measurement obtained for a person presenting at a measurement station that is one among one or more measurement stations within a facility. See the interface circuitry 14 of the system 10 depicted in FIG. 2, for one example of such a communication interface.

The example computer system further includes processing circuitry configured to evaluate the temperature measurement according to a trend analysis in which the temperature measurement is assessed in dependence on one or more trendlines determined from prior temperature measurements received for the person. The prior temperature measurements are represented in a data set corresponding to the person, where the data set is one among a plurality of data sets and is selected based on recognition of the person from among individual persons corresponding to respective ones of the data sets. The processing circuitry of the example computer system is further configured to output signaling to one or more alerting systems, in response to the evaluation indicating a potential medical condition of interest.

See the processing circuitry 12 of the system 10 depicted in FIG. 2 for an example implementation of the processing circuitry described immediately above.

The one or more measurement stations comprise one or more video cameras for recognition of persons, each video camera integrating or being associated with a thermal detector, for measuring temperatures of persons imaged by the video camera. Correspondingly, the example computer system is configured to based subject recognition on video images of subjects presenting at measurement stations.

The processing circuitry of the example computer system is configured to receive signaling as first signaling comprising a temperature measurement for a subject, where the first signaling is received directly or indirectly from the measurement station at which the temperature measurement was determined, and as second signaling indicating the person. The signaling may be received concurrently or at different times, with an identifier or other linkage between them. Either way, the processing circuitry uses the second signaling to recognize the person and it selects the corresponding data set from among the plurality of data sets, based on the recognition.

In one or more embodiments, the one or more measurement stations comprises multiple measurement stations at separate locations within the facility, and the processing circuitry of the example computer system is configured to compare temperature measurements collected over time at respective ones of the multiple measurement stations, or compare statistics derived therefrom, determine differences in measurement calibrations among the multiple measurement stations based on the comparisons, and compensate the temperature measurement or the trend analysis for the differences in measurement calibrations among the multiple measurement stations.

The processing circuitry is configured to perform the trend analysis, for example, by deriving a screening factor that depends on the temperature measurement and accounts for a historical temperature pattern of the respective person, where the processing circuitry is configured to evaluate the temperature measurement by determining whether the screening factor exceeds a threshold. The screening factor may be normalized according to the historical temperature pattern of the person, and the computer system may maintains a plurality of historical temperature patterns corresponding to respective ones among a plurality of persons, such that evaluating a particular temperature measurement received for a particular person from among the plurality of persons comprises evaluating the temperature measurement according to the historical temperature pattern corresponding to the particular person. In at least one embodiment, the screening factor further depends on a group screening value derived from temperatures observed for the plurality of persons.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1. A method performed by a computer system, the method comprising:
receiving signaling indicating a temperature measurement obtained for a person presenting at a measurement station that is one among one or more measurement stations within a facility;
evaluating the temperature measurement according to a trend analysis in which the temperature measurement is assessed in dependence on one or more trendlines determined from prior temperature measurements received for the person, the prior temperature measurements represented in a data set corresponding to the person, where the data set is one among a plurality of data sets and is selected based on recognition of the person from among individual persons corresponding to respective ones of the data sets; and
outputting signaling to one or more alerting systems, in response to the evaluation indicating a potential medical condition of interest.

2. The method of claim 1, wherein the one or more measurement stations comprise one or more video cameras for recognition of persons, each video camera integrating or being associated with a thermal detector, for measuring temperatures of persons imaged by the video camera.

3. The method of claim 2, wherein receiving the signaling indicating the temperature measurement comprises receiving the signaling via an Internet connection that communicatively couples the computer system to the one or more video cameras, or to a remote computer system that is local to the one or more video cameras.

4. The method of claim 1, wherein receiving the signaling comprising receiving first signaling comprising the temperature measurement, the first signaling received directly or indirectly from the measurement station at which the temperature measurement was determined.

5. The method of claim 4, further comprising receiving second signaling indicating the person, using the second signaling to recognize the person, and using the recognition to select the corresponding data set from among the plurality of data sets.

6. The method of claim 5, wherein the second signaling comprises image data and wherein the method further comprises recognizing the person based on processing the image data.

7. The method of claim 5, wherein the second signaling comprises access-control data associated with authorized persons entering or exiting access-controlled areas associated with the one or more measurement stations, and wherein the method further comprises recognizing the person from the access-control data.

8. The method of claim 1, wherein the one or more measurement stations comprises multiple measurement stations at separate locations within the facility, and wherein the method further comprises comparing temperature measurements collected over time at respective ones of the multiple measurement stations, or comparing statistics derived therefrom, determining differences in measurement calibrations among the multiple measurement stations based on the comparisons, and compensating the temperature measurement or the trend analysis for the differences in measurement calibrations among the multiple measurement stations.

9. The method of claim 1, wherein the trend analysis comprises deriving a screening factor that depends on the temperature measurement and accounts for a historical temperature pattern of the respective person, and wherein evaluating the temperature measurement comprises determining whether the screening factor exceeds a threshold.

10. The method of claim 9, wherein the screening factor is normalized according to the historical temperature pattern of the person, and wherein the computer system maintains a plurality of historical temperature patterns corresponding to respective ones among a plurality of persons, such that evaluating a particular temperature measurement received for a particular person from among the plurality of persons comprises evaluating the temperature measurement according to the historical temperature pattern corresponding to the particular person.

11. The method of claim 10, wherein the screening factor further depends on a group screening value derived from temperatures observed for the plurality of persons.

12. The method of claim 1, wherein outputting the signaling to the one or more alerting systems comprises initiating activation of a visible indicator or an audible indicator at the measurement station used to obtain the temperature measurement.

13. The method of claim 1, wherein outputting the signaling to the one or more alerting systems comprises sending one or more messages to one or more designated authorized persons.

14. A computer system comprising:
a communication interface configured to receive signaling indicating a temperature measurement obtained for a person presenting at a measurement station that is one among one or more measurement stations within a facility; and
processing circuitry configured to:
evaluate the temperature measurement according to a trend analysis in which the temperature measurement is assessed in dependence on one or more trendlines determined from prior temperature measurements received for the person, the prior temperature measurements represented in a data set corresponding to the person, where the data set is one among a plurality of data sets and is selected based on recognition of the person from among individual persons corresponding to respective ones of the data sets;
output signaling to one or more alerting systems, in response to the evaluation indicating a potential medical condition of interest.

15. The computer system of claim 14, wherein the one or more measurement stations comprise one or more video cameras for recognition of persons, each video camera integrating or being associated with a thermal detector, for measuring temperatures of persons imaged by the video camera.

16. The computer system of claim 1, wherein the processing circuitry is configured to:
receive the signaling as first signaling comprising the temperature measurement, the first signaling received directly or indirectly from the measurement station at which the temperature measurement was determined, and second signaling indicating the person;
recognize the person using the second signaling; and
select the corresponding data set from among the plurality of data sets, based on the recognition.

17. The computer system of claim 14, wherein the one or more measurement stations comprises multiple measurement stations at separate locations within the facility, and wherein the processing circuitry is configured to compare temperature measurements collected over time at respective ones of the multiple measurement stations, or compare statistics derived therefrom, determine differences in measurement calibrations among the multiple measurement stations based on the comparisons, and compensate the temperature measurement or the trend analysis for the differences in measurement calibrations among the multiple measurement stations.

18. The computer system of claim 14, wherein the processing circuitry is configured to perform the trend analysis by deriving a screening factor that depends on the temperature measurement and accounts for a historical temperature pattern of the respective person, and wherein the processing circuitry is configured to evaluate the temperature measurement by determining whether the screening factor exceeds a threshold.

19. The computer system of claim 18, wherein the screening factor is normalized according to the historical temperature pattern of the person, and wherein the computer system maintains a plurality of historical temperature patterns corresponding to respective ones among a plurality of persons, such that evaluating a particular temperature measurement received for a particular person from among the plurality of persons comprises evaluating the temperature measurement according to the historical temperature pattern corresponding to the particular person.

20. The computer system of claim 19, wherein the screening factor further depends on a group screening value derived from temperatures observed for the plurality of persons.
